(19) United States
(12) Patent Application Publication
(10) Pub. No.: US 2016/0347327 A1
(43) Pub. Date: Dec. 1, 2016

(54) AUTONOMOUS VEHICLE DRIVING ASSIST SYSTEM, METHOD, AND PROGRAM

(71) Applicant: AISIN AW CO., LTD., Anjo-shi, Aichi-ken (JP)

(72) Inventors: Yoshito KONDO, Okazaki (JP); Yuji SATO, Owariasahi (JP); Ken ISHIKAWA, Nagoya (JP)

(73) Assignee: AISIN AW CO., LTD., Anjo-shi, Aichi-ken (JP)

(21) Appl. No.: 15/116,354

(22) PCT Filed: Jan. 27, 2015
(86) PCT No.: PCT/JP2015/052127

§ 371 Date: Aug. 3, 2016

(30) Foreign Application Priority Data
Feb. 25, 2014 (JP) 2014-034516

(51) Int. Cl. B60W 50/08; B60W 50/00

(52) U.S. Cl. CPC B60W 50/082; B60W 50/0098; B60W 2050/0096; B60W 2550/402

(57) ABSTRACT

An autonomous vehicle driving assist system, method, and program set a planned route of a vehicle, the planned route including an autonomous driving section where autonomous driving control of the vehicle is permitted, and set a transition exclusion section of the planned route where a transition from autonomous driving control to manual driving is determined to be difficult. The system, method, and program set a transition section of the planned route where the transition from autonomous driving control to manual driving is made, and which excludes the transition exclusion section. Based on the transition section, the system, method, and program determine a section where autonomous driving control is performed in the planned route.

### TECHNICAL FIELD

Related technical fields include autonomous vehicle driving assist systems, methods, and programs which assist a vehicle in traveling by autonomous driving control.

### BACKGROUND ART

In recent years, many vehicles are equipped with navigation systems that provide the driver with travel guidance of the vehicle, so that the driver can easily arrive at a desired destination. The navigation systems are systems that can detect the current location of the vehicle by a GPS receiver etc. and obtain map data corresponding to the detected current location via a recording medium such as a DVD-ROM or an HDD or via a network to display the map data on a liquid crystal display monitor. The navigation systems also have a route search function to search for, when a desired destination is entered, a recommended route from the location of the vehicle to the destination. When the obtained recommended route is set as a guide route, the navigation systems display the guide route on a display screen and provide the user with voice guidance when the vehicle approaches an intersection etc., thereby reliably guiding the user to the desired destination. Recently, some mobile phones, smartphones, tablet computers, personal computers, etc. also have a function similar to that of the navigation systems.

In recent years, in addition to a manual drive mode in which the vehicle travels based on user's driving maneuvers, a drive mode using autonomous driving control has been proposed as a new drive mode, in which the vehicle autonomously travels along a preset route without user's driving maneuvers. For example, in autonomous driving control, the current location of the vehicle, the lane in which the vehicle is traveling, and the position of other vehicles around are detected as needed, and vehicle control such as control of steering, a driving source, and a brake is autonomously performed such that the vehicle travels along a present route. The drive mode using autonomous driving control is advantageous in that it can reduce the burden of driving on the user. However, it is practically difficult for the vehicle to travel only by autonomous driving control in the entire way from the start to the end, and there are also sections where user's manual driving is required. It is therefore desired to appropriately make a transition from the drive mode using autonomous driving control to the manual drive mode.

For example, Japanese Patent Application Publication No. 2008-290680 (JP 2008-290680 A) (pages 4 to 5, FIG. 2) proposes a technique of setting a transition point, or a point where a transition from the drive mode using autonomous driving control to the manual drive mode is made. In this technique, an evacuation area such as a parking area is set between the transition point and an end point of a section where autonomous driving control can be performed (e.g., an interchange (IC) exit), and the vehicle is guided to the evacuation area if a transition from the drive mode using autonomous driving control to the manual drive mode was not able to be made at the transition point.

### SUMMARY

In the technique described in JP 2008-290680 A, any desired point located before an end point of a section where autonomous driving control can be performed (e.g., an IC exit) is set as a transition point. However, since the transition point is the point where the user who was not maneuvering the vehicle starts maneuvering the vehicle, the transition point need be set in a location that does not impose a great burden on the user who starts driving the vehicle. For example, if the transition point is set in a low visibility section or a section where complicated maneuvers are required, the user needs to make such maneuvers immediately after the transition although he/she has not gotten used to driving again, and this imposes a great burden on the user. If the transition point is set in a parking area or a rest area, the place in which the transition point can be set is limited, which makes a section where autonomous driving control can be performed unnecessarily short.

In order to solve the above conventional problems, it is an object of exemplary embodiments of the broad inventive principles described herein to provide an autonomous driving assist system, an autonomous driving assist method, and a computer program, which reduce the burden that is imposed on the user when a transition from autonomous driving control to manual driving using user's driving maneuvers is made and which prevent a section where autonomous driving control is performed from becoming unnecessarily short.

Exemplary embodiments provide an autonomous vehicle driving assist system, method, and program that set a planned route of a vehicle, the planned route including an autonomous driving section where autonomous driving control of the vehicle is permitted, and set a transition exclusion section of the planned route where a transition from autonomous driving control to manual driving is determined to be difficult. The system, method, and program set a transition section of the planned route where the transition from autonomous driving control to manual driving is made, and which excludes the transition exclusion section. Based on the transition section, the system, method, and program determine a section where autonomous driving control is performed in the planned route.

According to the autonomous driving assist system, the autonomous driving assist method, and the computer system having the above configuration, the transition section where a transition from autonomous driving control to manual driving is made is set in the planned route excluding the section where a transition from autonomous driving control to manual driving using user's driving maneuvers is determined to be difficult to make. This can reduce the burden that is imposed on the user when a transition from autonomous driving control to manual driving is made. For example, the user is not required to perfoim complicated maneuvers or advanced maneuvers immediately after the transition, namely when he/she has not gotten used to driving again. This allows a smooth transition from autonomous driving control to manual driving to be made, so that the vehicle can travel stably even after the transition to manual driving. The place in which the transition section can be set is not limited to a rest area or a parking area, and the transition section can also be set on a mainline. This can prevent the section where autonomous driving control is performed from becoming unnecessarily short.

### BRIEF DESCRIPTION OF THE DRAWINGS

FIG. 1 is a block diagram showing the configuration of a navigation system according to a first embodiment.

FIG. 2 is a flowchart of an autonomous driving implementation section setting program according to the first embodiment.

FIG. 3 is a diagram illustrating a method for setting a candidate transition section.

FIG. 4 is a diagram showing an example of the content of autonomous driving control that is set for a planned route of a vehicle.

FIG. 5 is a flowchart of an autonomous driving implementation section setting program according to a second embodiment.

FIG. 6 is a diagram showing an example of a lane travel plan.

### DETAILED DESCRIPTION OF EXEMPLARY EMBODIMENTS

An autonomous driving assist system will be described in detail based on first and second embodiments of a navigation system with reference to the accompanying drawings.

### First Embodiment

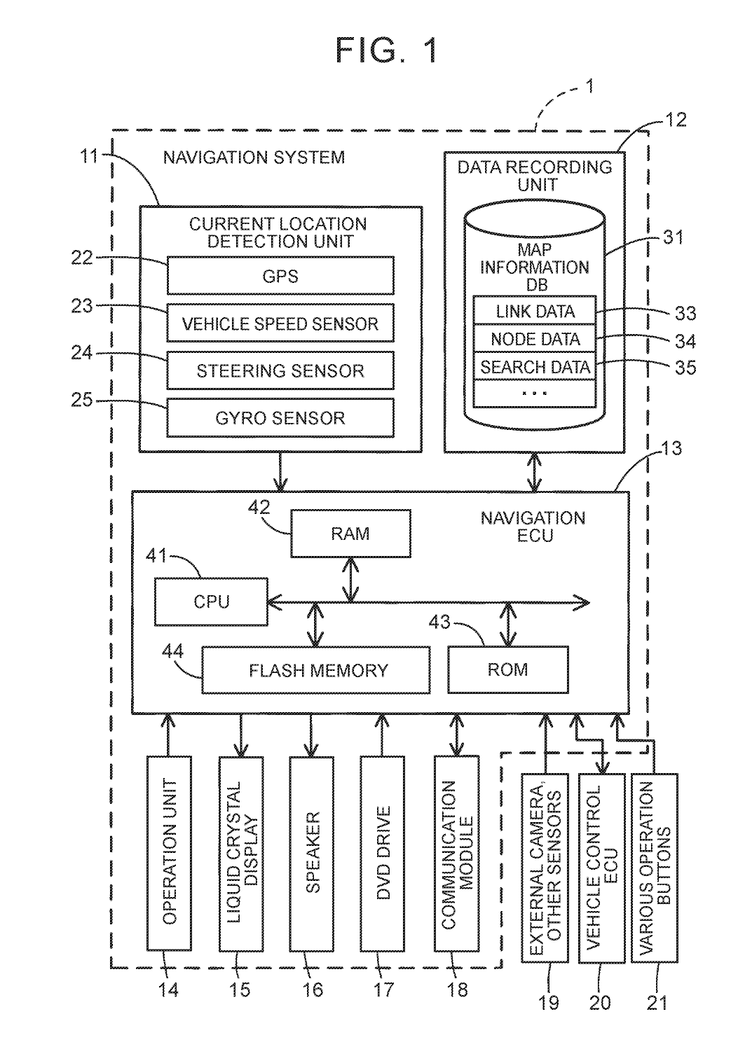

First, the general configuration of a navigation system 1 according to a first embodiment will be described with reference to FIG. 1. FIG. 1 is a block diagram of the navigation system 1 of the first embodiment.

As shown in FIG. 1, the navigation system 1 of the first embodiment is formed by: a current location detection unit 11 that detects the current location of a vehicle equipped with the navigation system 1; a data recording unit 12 having various data recorded thereon; a navigation ECU 13 that performs various arithmetic operations based on received information; an operation unit 14 that accepts user's operation; a liquid crystal display 15 that displays to the user a map around the vehicle, information on a guide route (planned route of the vehicle) set by the navigation system 1, etc.; a speaker 16 that outputs voice guidance about the route; a DVD drive 17 that reads a DVD, or a storage medium; and a communication module 18 that communicates with an information center such as a probe center or a Vehicle Information and Communication System (VICS (registered trademark)) center. The navigation system 1 is connected via an in-vehicle network such as a CAN to an external camera 19 and various sensors which are mounted on the vehicle equipped with the navigation system 1. The navigation system 1 is also connected to a vehicle control ECU 20 that performs various controls on the vehicle equipped with the navigation system 1, such that the navigation system 1 and the vehicle control ECU 20 can communicate with each other in two ways. The navigation system 1 is also connected to various operation buttons 21 mounted on the vehicle, such as an autonomous driving switch and an autonomous driving start button.

Components of the navigation system 1 will be sequentially described below.

The current location detection unit 11 is formed by a GPS 22, a vehicle speed sensor 23, a steering sensor 24, a gyro sensor 25, etc. and can detect the current location and direction of the vehicle, the traveling speed of the vehicle, the current time, etc. In particular, the vehicle speed sensor 23 is a sensor that detects the distance traveled by the vehicle and the vehicle speed. The vehicle speed sensor 23 generates pulses according to rotation of drive wheels of the vehicle and outputs a pulse signal to the navigation ECU 13. The navigation ECU 13 counts the number of generated pulses to calculate the rotational speed of the drive wheels and the traveled distance. The navigation system 1 need not necessarily include all of these four sensors. The navigation system 1 may include only one or more of these sensors.

The data recording unit 12 includes a hard disk (not shown) as an external storage device and as a storage medium, and a recording head (not shown) that is a driver for reading a map information database DB 31, a predetermined program, etc. recorded on the hard disk and writing predetermined data on the hard disk. (As used herein, the terms “storage medium” and “storage media” are not intended to encompass transitory signals.) The data recording unit 12 may be formed by a memory card or an optical disk such as a CD or a DVD instead of the hard disk. The map information DB 31 may be stored in an external server, and the navigation system 1 may communicate with the external server to obtain the map information DB 31.

The map information DB 31 is storage means having stored therein, e.g., link data 33 relating to roads (links), node data 34 relating to node points, search data 35 that is used for processing associated with a route search or a route change, facility data relating to facilities, map display data for displaying a map, intersection data relating to each intersection, search data for searching for locations, etc.

Data that is recorded as the link data 33 is: data on each link that forms a road to which the link belongs, namely data indicating the width, slope, cant, and bank of the road, the road surface condition, a merging section, the road structure, whether or not there is any sidewall installed at the roadside, the number of lanes on the road, the location where the number of lanes decreases, the place where the road width decreases, a railroad crossing, etc.; data on a corner, namely data indicating the radius of curvature, an intersection, a T-junction, the entrance and exit of the corner, etc.; data on road attributes, namely data indicating a downhill road, an uphill road, etc.; and data on road type, namely data indicating a local road such as a national highway, a prefectural (state) road, or a narrow street, and a toll road such as a national expressway, an urban expressway, an exclusive automobile road, a local toll road, or a toll bridge.

Data that is recorded as the node data 34 include data on: a branch point (including an intersection, a T-junction, etc.) of an actual road; the coordinates (positions) of node points set at predetermined intervals on each road according to the radius of curvature etc.; node attributes indicating whether the node is a node corresponding to an intersection or not etc.; a connection link number list, or a list of link numbers of links connecting to the node; an adjacent node number list, or a list of node numbers of nodes located adjacent to the node with a link therebetween; and the height (altitude) of each node point.

Various data that is used for a route search process of searching for a route from a point of departure (e.g., the current location of the vehicle) to a set destination is recorded as the search data 35. Specifically, cost calculation data that is used to calculate search cost such as cost obtained by converting level of appropriateness into numbers as a route regarding an intersection (hereinafter referred to as the “intersection cost”) and cost obtained by converting level of appropriateness into numbers as a route regarding a link forming a road (hereinafter referred to as the “link cost”) is stored as the search data 35.

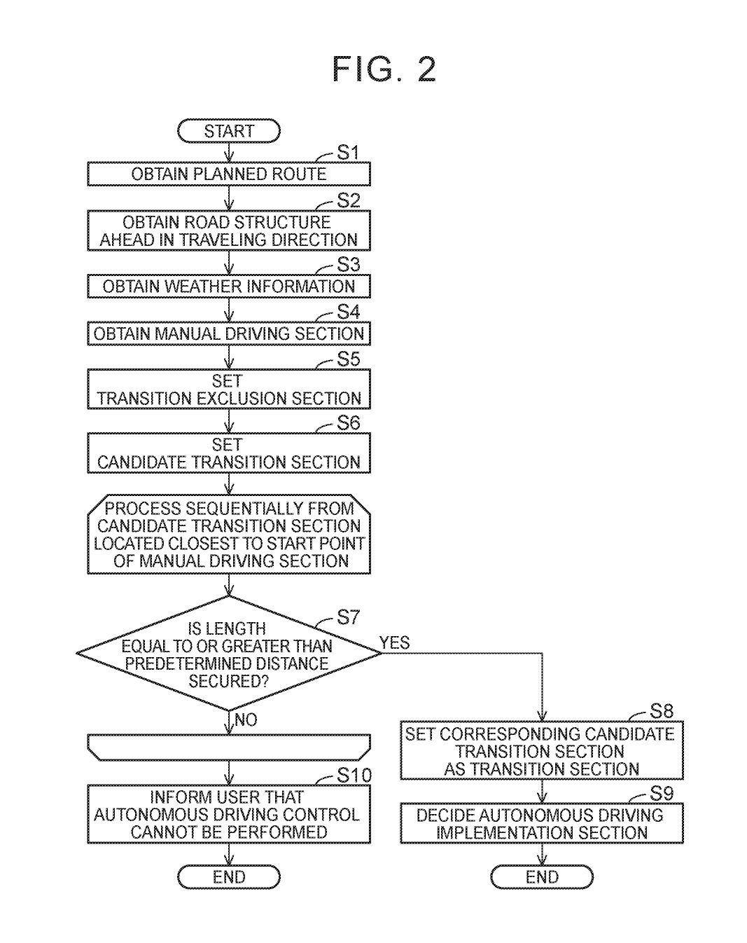

The navigation electronic control unit (ECU) 13 is an electronic control unit that generally controls the navigation system 1. The navigation ECU 13 includes: a CPU 41 as an arithmetic unit and a control unit; and internal storage media such as a RAM 42 that is used as a working memory when the CPU 41 performs various arithmetic operations and that stores route data etc. when a route search is conducted, a ROM 43 having recorded thereon an autonomous driving implementation section setting program (see FIG. 2) described below etc in addition to a control program, and a flash memory 44 that stores a program read from the ROM 43. The navigation ECU 13 forms various means as a processing algorithm. For example, route setting means sets a planned route of the vehicle including an autonomous driving section where autonomous driving control of the vehicle is permitted. Exclusion section setting means sets, as a transition exclusion section, a section where a transition from autonomous driving control to manual driving using user's driving maneuvers is determined to be difficult to make in the planned route. Transition section setting means sets a transition section where a transition from autonomous driving control to manual driving is made in the planned route excluding the transition exclusion section. Autonomous driving section deciding means decides a section where autonomous driving control is performed in the planned route, according to the transition section set by the transition section setting means. Manual driving section obtaining means obtains a manual driving section where the vehicle needs to travel by manual driving in the planned route. Control content setting means sets the content of autonomous driving control to be performed on the vehicle in the section where autonomous driving control is performed in the planned route.

The operation unit 14 is operated to enter a point of departure as a start point and a destination as an end point etc., and is formed by a plurality of operation switches (not shown) such as various keys and buttons. The navigation ECU 13 performs control so as to execute various operations based on switch signals output in response to depression etc. of the switches. The operation unit 14 may be formed by a touch panel that is provided on the front surface of the liquid crystal display 15. Alternatively, the operation unit 14 may be formed by a microphone and a speech recognition device.

A map image including a road, traffic information, operation guidance, an operation menu, key guidance, guidance information according to a guide route (planned route), news, a weather forecast, time, an email, a TV program, etc. are displayed on the liquid crystal display 15. An HUD or an HMD may be used instead of the liquid crystal display 15.

The speaker 16 outputs voice guidance that tells the user the directions along a guide route based on a command from the navigation ECU 13, and guidance of traffic information.

The DVD drive 17 is a drive that can read data recorded on a recording medium such as a DVD or a CD. The DVD drive 17 plays music or images, updates the map information DB 31, etc. based on the read data.

The communication module 18 is a communication device that receives traffic information, probe information, weather information, etc. transmitted from a traffic information center such as, e.g., a VICS center or a probe center. For example, the communication module 18 is a mobile phone or a DCM. Examples of the communication module 18 further include a vehicle-to-vehicle communication device for communication between vehicles, and a road-to-vehicle communication device for communication between a vehicle and a roadside unit.

The external camera 19 is, e.g., a camera using a solid state imaging element such as a CCD. The external camera 19 is attached to the vehicle at a position above a front bumper and is mounted such that its optical axis is tilted downward at a predetermined angle with respect to the horizontal direction. The external camera 19 captures an image ahead of the vehicle in the traveling direction when the vehicle travels in an autonomous driving section. The vehicle control ECU 20 processes the captured image to detect pavement markings applied to the road on which the vehicle is traveling, other vehicles around, etc., and performs autonomous driving control of the vehicle based on the detection result. The external camera 19 may be placed on the rear or side part of the vehicle instead of on the front part of the vehicle. Instead of the camera, a sensor such as a millimeter wave radar, vehicle-to-vehicle communication, or road-to-vehicle communication may be used as means for detecting other vehicles.

Drive modes of the vehicle include a drive mode using autonomous driving control in which the vehicle autonomously travels along a preset route without user's driving maneuvers, in addition to a manual drive mode in which the vehicle travels based on user's driving maneuvers. For example, in autonomous driving control, the current location of the vehicle, the lane in which the vehicle is traveling, and the location of other vehicles around are detected as needed, and vehicle control such as control of steering, a driving source, and a brake is autonomously performed by the vehicle control ECU 20 such that the vehicle travels along a preset route. Since autonomous driving control is already known in the art, detailed description thereof will be omitted. Autonomous driving control may be performed in all road sections. In the following description, however, a freeway having gates (either manned or unmanned, and either toll or toll-free) at boundaries with other roads connecting to the freeway is set as an autonomous driving section where autonomous driving control of the vehicle is performed, and the autonomous driving control is basically performed only when the vehicle is traveling in the autonomous driving section. Other sections may be set as an autonomous driving section. For example, a national expressway, an urban expressway, an exclusive automobile road, a toll road, or a local road may be set as an autonomous driving section. Autonomous driving control is not always performed when the vehicle travels in an autonomous driving section, but is performed only when autonomous driving control is selected by the user and only in a situation where it is appropriate for the vehicle to travel by autonomous driving control. Namely, the autonomous driving section is a section where autonomous driving control of the vehicle is permitted in addition to manual driving.

The vehicle control ECU 20 is an electronic control unit that controls the vehicle equipped with the navigation system 1. The vehicle control ECU 20 is connected to each driving part of the vehicle such as steering, a brake, and an accelerator. In the first embodiment, the vehicle control ECU 20 controls each driving part to perform autonomous driving control of the vehicle particularly when the vehicle travels in an autonomous driving section. The navigation ECU 13 sends a command signal regarding autonomous driving control to the vehicle control ECU 20 via a CAN when a planned route (guide route) of the vehicle has been decided. The vehicle control ECU 20 performs autonomous driving control after the start of traveling according to the received command signal. The command signal contains information that specifies the planned route (guide route) and information that shows the set content of autonomous driving control (e.g., travel straight, make a lane change to the right, merge, etc.) to be performed on the vehicle in an autonomous driving section included in the planned route. The navigation ECU 13 may send the content of autonomous driving control when a section where autonomous driving control is performed has been decided as described below, instead of when a planned route has been decided.

The autonomous driving implementation section setting program that is executed by the CPU 41 in the navigation system 1 of the first embodiment having the above configuration will be described with reference to FIG. 2. FIG. 2 is a flowchart of the autonomous driving implementation section setting program according to the first embodiment. The autonomous driving implementation section setting program is a program that is executed after a planned route (guide route) of the vehicle is decided and that sets a section where autonomous driving control is performed on the vehicle. The program shown in the flowchart of FIG. 2 is stored in the RAM 42 and the ROM 43 of the navigation system 1 and is executed by the CPU 41.

In the autonomous driving implementation section setting program, the CPU 41 first obtains in step (hereinafter abbreviated as “S”) 1 a planned route (guide route) currently set in the navigation system 1. For example, when the user starts driving, he/she sets a destination, whereby the CPU 41 obtains a plurality of route options by a route search process using known Dijkstra's algorithm, and the planned route is decided from the plurality of route options by user's operation. In the following description, the planned route includes an autonomous driving section, and the vehicle basically travels by autonomous driving control in the autonomous driving section unless the user intentionally cancels the autonomous driving control.

Next, in S2, the CPU 41 obtains from the map information DB 31 the road structure ahead of the vehicle in the traveling direction along the planned route. The road structure obtained in S2 includes information specifying, in the case where there is a connection point of roads, how the roads are connected at the connection point, information specifying a merging section where the vehicle merges into traffic at the connection point, whether there is any sidewall installed at the roadside, the curvature of a curve, the slope of the road surface, the condition of the road surface (a step or a bad road), etc.

Then, in S3, the CPU 41 communicates with an external center via the communication module 18 to obtain weather information around the vehicle. The weather information includes information about rainfall, snowfall, and wind, etc. The weather may be detected by a rainfall sensor etc. mounted on the vehicle.

Thereafter, in S4, the CPU 41 obtains a manual driving section where the vehicle needs to travel by manual driving in the planned route. The manual driving section includes a section that is not an autonomous driving section (e.g., a freeway) and a section where it is difficult for the vehicle to travel by autonomous driving control even within the autonomous driving section. The section where it is difficult for the vehicle to travel by autonomous driving control is specified based on the road shape, pavement markings, traffic information, weather information, past history of stopping of autonomous driving control, etc. For example, a section that meets any of the following conditions (1) to (5) is specified as the section where it is difficult for the vehicle to travel by autonomous driving control.

(1) A section where the vehicle needs to merge into traffic or make a lane change within a short distance (e.g., 500 m or less).

(2) A section where a pavement marking (a centerline, a lane marking, a roadway edge marking, etc.) is missing or has faded to such a degree that the pavement marking cannot be recognized by a camera.

(3) A section where there is a restricted lane due to an accident, construction work, a falling object, etc., but the restricted lane cannot be identified.

(4) A section where the weather is difficult to detect by a camera or a sensor when the vehicle is traveling, or where it is difficult to control the vehicle due to the weather (e.g., heavy rain, dense fog, fallen snow, or a frozen road surface).

(5) A section other than (1) to (4) where autonomous driving control was stopped in the past.

In the case where the planned route of the vehicle has a plurality of manual driving sections, the CPU 41 may obtain all the manual driving sections or may obtain only the manual driving section located ahead of, and closest to, the current location of the vehicle in the traveling direction. In the following description, the CPU 41 obtains only the manual driving section located ahead of, and closest to, the current location of the vehicle in the traveling direction.

Subsequently, in S5, the CPU 41 sets, as a transition exclusion section, a section where a transition from autonomous driving control to manual driving using user's driving maneuvers is determined to be difficult to make in the planned route. For example, the section where a transition from autonomous driving control to manual driving is determined to be difficult to make is a section where the burden of vehicle maneuvers to be performed by the user after the transition to manual driving is greater than a certain amount. The certain amount herein refers to the upper limit of the burden of maneuvers that can be appropriately performed by a general user immediately after he/she starts driving. For example, the section where the burden of vehicle maneuvers to be performed by the user after the transition to manual driving is greater than the certain amount is a section that meets any one of the following conditions (A) to (D).

(A) A low visibility section where it is difficult to visually recognize surrounding objects due to a sidewall installed at the roadside or bad weather.

(B) A section with a bad road surface condition such as a step, a frozen road surface, or an unpaved road.

(C) A section where a predetermined amount or more of break operation or steering operation need be performed within a predetermined time due to merging traffic, a road branching off, a curve, a slope, etc.

(D) A section where the wind is blowing hard (e.g., a wind speed of 15 m/s or higher).

The CPU 41 may obtain all the transition exclusion sections included in the planned route or may obtain only the transition exclusion section located ahead of the current location of the vehicle in the traveling direction and before the manual driving section obtained in S4.

Subsequently, in S6, the CPU 41 sets a candidate transition section that is a candidate for a transition section where a transition from autonomous driving control to manual driving is made. In the planned route, a section that is located ahead of the current location of the vehicle in the traveling direction and before the start point of the manual driving section obtained in S4 and that is other than the transition exclusion section is set as a candidate transition section. If there are a plurality of sections that can be set as a candidate transition section, each of the sections is set as a candidate transition section.

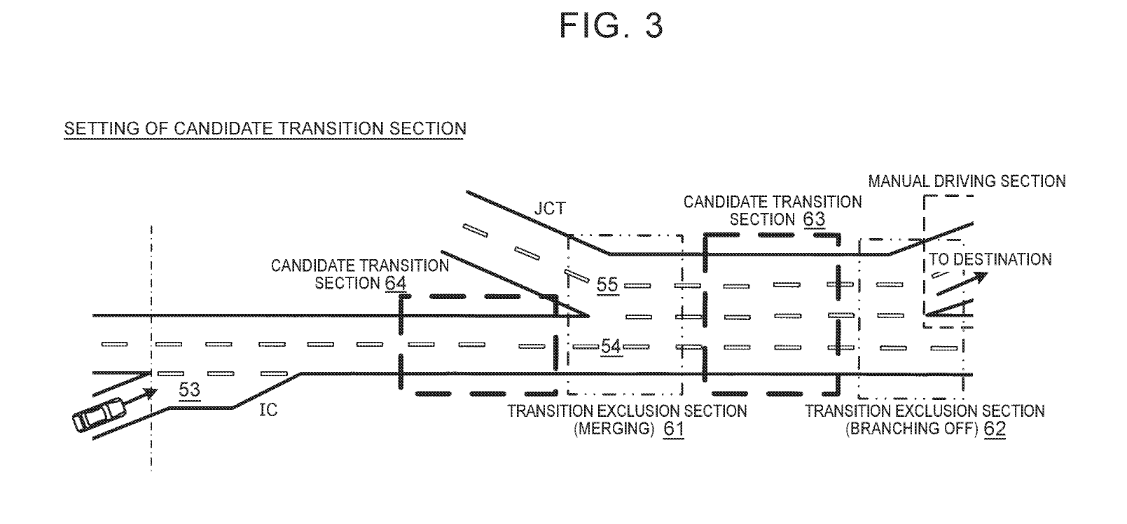

A method for setting a candidate transition section will be described with respect to, e.g., the case where the vehicle travels in a section having such a road structure that an interchange IC and a junction JC are successively located as shown in FIG. 3 along the planned route. In the example shown in FIG. 3, the vehicle enters a mainline 54 from a ramp 53 at the IC and then enters another road 55 from the mainline 54 at the JCT. The road 55 is not a road defined in the autonomous driving section. Namely, a section where the vehicle travels after it enters the road 55 is obtained as a manual driving section in S4. A section from the start point of connection between the mainline 54 and the road 55 to the point located a predetermined distance away from the start point of connection between the mainline 54 and the road 55 is a merging section where the vehicle merges into traffic. In this section, the user is likely to perform complicated vehicle maneuvers to merge into traffic. This section is therefore set as a transition exclusion section 61. Moreover, in a section from the point located a predetermined distance before the end point of connection between the mainline 54 and the road 55 to the end point of connection between the mainline 54 and the road 55, the user is likely to perform vehicle maneuvers to turn the vehicle or make a lane change as the road is branching off. Accordingly, this section is also set as a transition exclusion section 62. As a result, sections 63, 64 are extracted as sections that are located ahead of the current location of the vehicle in the traveling direction and before the start point of the manual driving section and that are other than the transition exclusion sections 61, 62. The sections 63, 64 are set as candidate transition sections.

Thereafter, in S7, the CPU 41 determines, for each of the candidate transition sections set in S6, if the length of the candidate transition section is equal to or greater than a predetermined distance, sequentially from the candidate transition section located closest to the start point of the manual driving section. The predetermined distance used in the determination in S7 is the lower limit of the distance that allows a transition from autonomous driving control to manual driving to be appropriately made. For example, the predetermined distance is 500 m.

For example, in the example shown in FIG. 3, the CPU 41 first determines if the length of the candidate transition section 63 located closest to the start point of the manual driving section out of the candidate transition sections 63, 64 is equal to or greater than the predetermined distance. If the CPU 41 determines that the length of the candidate transition section 63 is smaller than the predetermined distance, it subsequently determines if the length of the candidate transition section 64 is equal to or greater than the predetermined length. The CPU 41 repeatedly performs the determination process of S7 in a similar manner until it finds a candidate transition section having a length equal to or greater than the predetermined distance.

If the CPU 41 determines that there is a candidate transition section for which the length equal to or greater than the predetermined distance can be secured (S7: YES), it sets the candidate transition section which is located closest to the start point of the manual driving section and for which the length equal to or greater than the predetermined distance can be secured, as a transition section where a transition from autonomous driving control to manual driving is made (S8).

Subsequently, in S9, the CPU 41 decides a section where autonomous driving control is performed (hereinafter referred to as the “autonomous driving implementation section”) in the planned route, according to the transition section set in S8. Specifically, the autonomous driving implementation section is a section up to the start point of the transition section set in S8 in the autonomous driving section. The CPU 41 then sets the content of autonomous driving control (e.g., travel straight, make a lane change to the right, merge, etc.) to be performed on the vehicle in the autonomous driving implementation section.

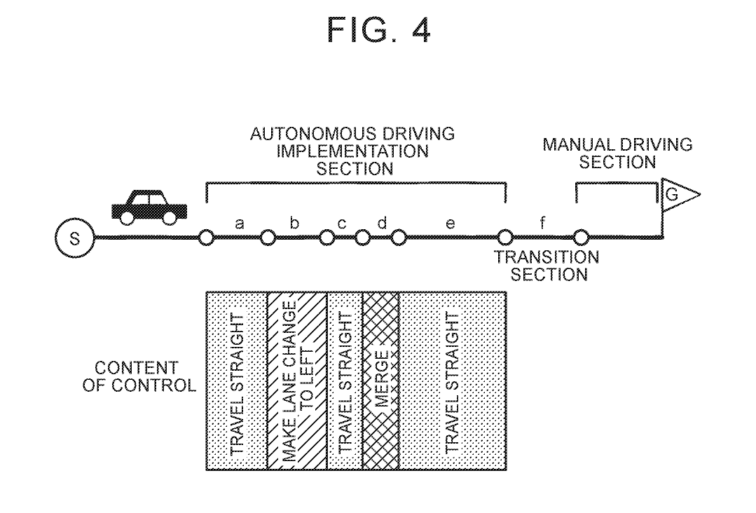

For example, FIG. 4 is a diagram showing an example of the content of autonomous driving control that is set in the case where a section f of the planned route of the vehicle is set as a transition section and sections a to e of the planned route of the vehicle are autonomous driving implementation sections. In the example shown in FIG. 4, the content of autonomous driving control are set for the sections a to e. The content of autonomous driving control is basically decided based on the planned route and map information. For example, for a section where the vehicle needs to merge into a mainline at an IC etc., “merge” is set as the content of autonomous driving control. Moreover, “make a lane change to the right (left)” is set for a section where the vehicle needs to make a lane change in order to move to another freeway at a JCT etc. The CPU 41 sends information specifying the planned route and the set content of autonomous driving control to the vehicle control ECU 20 via the CAN. Accordingly, when the vehicle starts traveling, the vehicle control ECU 20 performs autonomous driving control after the start of traveling according to the information received from the navigation system 1.

If the CPU 41 deter nines that there is no candidate transition section for which the length equal to or greater than the predetermined distance can be secured (S7: NO), the routine proceeds to S10.

In S10, the CPU 41 informs the user that autonomous driving control of the vehicle is not going to be performed. The CPU 41 does not set an autonomous driving implementation section. That is, the vehicle does not travel by autonomous driving control even if it subsequently enters the autonomous driving section.

As described in detail above, in the navigation system 1 according to the first embodiment, the autonomous driving assist method using the navigation system 1, and the computer program that is executed by the navigation system 1, the navigation system 1 obtains a planned route of the vehicle including an autonomous driving section where autonomous driving control of the vehicle is permitted (S1), sets, as a transition exclusion section, a section where a transition from autonomous driving control to manual driving using user's driving maneuvers is determined to be difficult to make in the planned route (S5), sets a transition section where a transition from autonomous driving control to manual driving is made in the planned route excluding the transition exclusion section (S8), and decides, according to the set transition section, a section where autonomous driving control is performed in the planned route (S9). This can reduce the burden that is imposed on the user when a transition from autonomous driving control to manual driving is made. For example, the user is not required to perform complicated maneuvers or advanced maneuvers immediately after the transition, namely when he/she has not gotten used to driving again. This allows a smooth transition from autonomous driving control to manual driving to be made, so that the vehicle can travel stably even after the transition to manual driving. The place that can be set as a transition section is not limited to a rest area or a parking area, and a mainline can also be set as a transition section. This can prevent the section where autonomous driving control is performed from becoming unnecessarily short.

### Second Embodiment

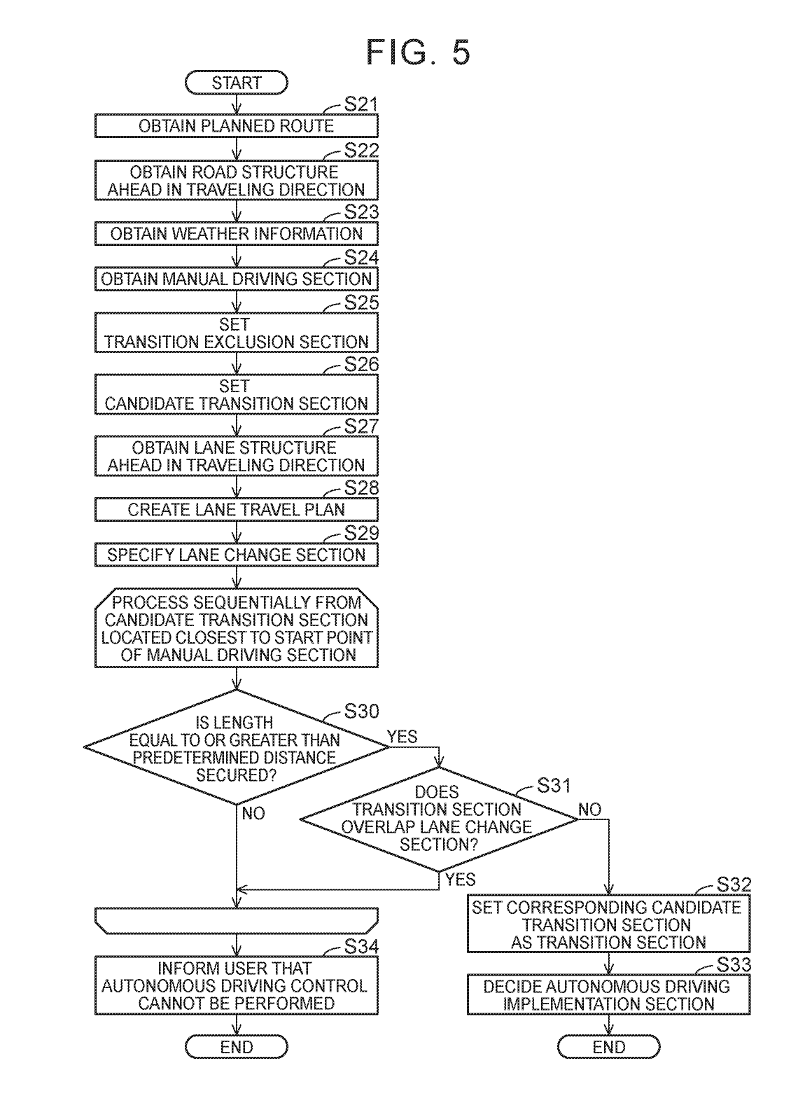

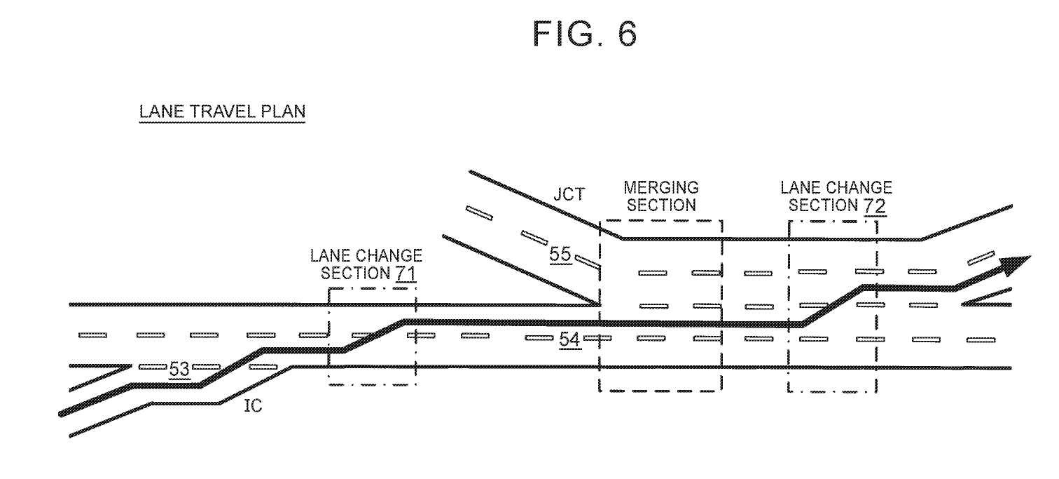

Next, a navigation system according to a second embodiment will be described below with reference to FIGS. 5 and 6. In the following description, the same reference characters as those in the configuration of the navigation system 1 of the first embodiment in FIGS. 1 to 4 denote the same or corresponding portions as or to those in the configuration of the navigation system 1 of the first embodiment.

The general configuration of the navigation system of the second embodiment is substantially the same as that of the navigation system 1 of the first embodiment. Various control processes of the navigation system 1 of the second embodiment are also substantially the same as those of the navigation system of the first embodiment. The navigation system of the second embodiment is different from that of the first embodiment in that it also uses a lane travel plan, or a plan of how the vehicle travels in a lane when it travels along a planned route, to set a transition section where a transition from autonomous driving control to manual driving is made.

An autonomous driving implementation section setting program that is executed by the CPU 41 in the navigation system of the second embodiment will be described below with reference to FIG. 5, FIG. 5 is a flowchart of the autonomous driving implementation section setting program according to the second embodiment.

Since the processes of S21 to S26 are similar to those of S1 to S6 in the autonomous driving implementation section setting program (FIG. 2) of the first embodiment, description thereof will be omitted.

Next, in S27, the CPU 41 obtains from the map information DB 31 the lane structure ahead of the vehicle in the traveling direction along the planned route. The lane structure obtained in S27 includes information specifying the number of lanes and an increase or decrease in the number of lanes, etc.

Then, in S28, the CPU 41 creates a lane travel plan, or a plan of how the vehicle travels in a lane when it travels along the planned route, based on the road structure obtained in S22 and the lane structure obtained in S27. In particular, the lane travel plan includes a plan of how the vehicle moves between lanes when it travels on a road having a plurality of lanes. FIG. 6 is a diagram showing an example of the lane travel plan. The example of FIG. 6 shows a lane travel plan that is carried out when the vehicle enters the mainline 54 from the ramp 53 at the IC and then enters another road 55 from the mainline 54 at the JCT. In the lane travel plan, how the vehicle travels is basically decided such that the vehicle does not make any lane change in a merging section where the vehicle merges into traffic. Since creation of the lane travel plan is already known in the art, detailed description thereof will be omitted. In the case where autonomous driving control of the vehicle is performed, the autonomous driving control is performed such that the vehicle travels according to the created lane travel plan.

Thereafter, in S29, the CPU 41 specifies particularly a lane change section where the vehicle makes a lane change in the lane travel plan created in S28. For example, the lane travel plan shown in FIG. 6 has two lane changes, and the CPU 41 specifies sections 71, 72 as lane change sections.

Subsequently, in S30 and S31, the CPU 41 determines, for each of the candidate transition sections set in S26, if the length of the candidate transition section is equal to or greater than a predetermined distance and if the candidate transition section does not overlap the lane change section in the lane travel plan, sequentially from the candidate transition section located closest to the start point of the manual driving section. The predetermined distance used in the determination in S30 is the lower limit of the distance that allows a transition from autonomous driving control to manual driving to be appropriately made. For example, the predetermined distance is 500 m.

For example, in the example shown in FIG. 3, the CPU 41 first determines if the length of the candidate transition section 63 located closest to the start point of the manual driving section out of the candidate transition sections 63, 64 is equal to or greater than the predetermined distance and if the candidate transition section 63 does not overlap the lane change section. If the CPU 41 determines that the length of the candidate transition section 63 is smaller than the predetermined distance or that the candidate transition section 63 overlaps the lane change section, it subsequently determines if the length of the candidate transition section 64 is equal to or greater than the predetermined length and if the candidate transition section 64 does not overlap the lane change section. The CPU 41 repeatedly performs the determination processes of S30 and S31 in a similar manner until it finds a candidate transition section that has a length equal to or greater than the predetermined distance and that does not overlap the lane change section.

If the CPU 41 determines that there is a candidate transition section that has a length equal to or greater than the predetermined distance and that does not overlap the lane change section (530: YES, S31: NO), it sets the candidate transition section which is located closest to the start point of the manual driving section, for which the length equal to or greater than the predetermined distance can be secured, and which does not overlap the lane change section, as a transition section where a transition from autonomous driving control to manual driving is made (S32).

Subsequently, in S33, the CPU 41 decides a section where autonomous driving control is performed (hereinafter referred to as the “autonomous driving implementation section”) in the planned route, according to the transition section set in S32. Specifically, the autonomous driving implementation section is a section up to the start point of the transition section set in S32 in the autonomous driving section. The CPU 41 then sets the content of autonomous driving control (e.g., travel straight, make a lane change to the right, merge, etc.) to be performed on the vehicle in the autonomous driving implementation section (see FIG. 4).

If the CPU 41 determines that there is no candidate transition section for which the length equal to or greater than the predetermined distance can be secured and which does not overlap the lane change section (S30: NO, S31: YES), the routine proceeds to S34.

In S34, the CPU 41 informs the user that autonomous driving control of the vehicle is not going to be performed. The CPU 41 does not set an autonomous driving implementation section. That is, the vehicle does not travel by autonomous driving control even if it subsequently enters the autonomous driving section.

As described in detail above, in the navigation system 1 according to the second embodiment, the autonomous driving assist method using the navigation system 1, and the computer program that is executed by the navigation system 1, the navigation system 1 obtains a planned route of the vehicle including an autonomous driving section where autonomous driving control of the vehicle is permitted (S21), sets, as a transition exclusion section, a section where a transition from autonomous driving control to manual driving using user's driving maneuvers is determined to be difficult to make in the planned route (S35), creates a lane travel plan, or a plan of how the vehicle travels in a lane when it travels along a planned route (S28), sets a transition section where a transition from autonomous driving control to manual driving is made in the planned route excluding both the transition exclusion section and a lane change section where the vehicle makes a lane change in the lane travel plan (S32), and decides a section where autonomous driving control is performed in the planned route, according to the set transition section (S33). This can reduce the burden that is imposed on the user when a transition from autonomous driving control to manual driving is made. For example, the user is not required to perform complicated maneuvers such as a lane change or advanced maneuvers immediately after the transition, namely when he/she has not gotten used to driving again. This allows a smooth transition from autonomous driving control to manual driving to be made, so that the vehicle can travel stably even after the transition to manual driving. The place that can be set as a transition section is not limited to a rest area or a parking area, and a mainline can also be set as a transition section. This can prevent the section where autonomous driving control is performed from becoming unnecessarily short.

It should be understood that various improvements and modifications can be made without departing from the spirit and scope of the broad inventive principles.

For example, in the first and second embodiments, the range in which autonomous driving control is performed is decided from the section located ahead of the vehicle in the traveling direction along the planned route when the vehicle is traveling. However, the range in which autonomous driving control is performed may be decided from the entire planned route at the time the planned route has been decided. That is, the CPU 41 may obtain all the manual driving sections included in the planned route in S4 and S24 and may perform for each of the obtained manual driving sections the processes of S5 and the subsequent steps and the processes of S25 and the subsequent steps.

In the second embodiment, the CPU 41 determines, for each candidate transition section, if the length of the candidate transition section is equal to or greater than the predetermined distance and if the candidate transition section does not overlap the lane change section (S30, S31). However, the CPU 41 may first determine for each candidate transition section only if the length of the candidate transition section is equal to or greater than the predetermined distance and tentatively decide as a transition section the candidate transition section located closest to the start point of the manual driving section and having a length equal to or greater than the predetermined distance, and then determine if the tentatively decided transition section does not overlap the lane change section.

In the first and second embodiments, the navigation system 1 sets the content of autonomous driving control (e.g., travel straight, make a lane change to the right, merge, etc.) to be performed on the vehicle. However, the vehicle control ECU 20 may set the content of autonomous driving control. The content of autonomous driving control need not necessarily be set at the time a route search is conducted or at the time an autonomous driving implementation section is decided. The content of autonomous driving control need only be set by the time the vehicle reaches an autonomous driving section.

In the first and second embodiments, a control process in which the vehicle control ECU 20 controls all of an accelerator operation, a brake operation, and a steering wheel operation, which are the maneuvers related to the behavior of the vehicle out of vehicle maneuvers, is described as autonomous driving control that is performed such that the vehicle travels autonomously without user's driving maneuvers. However, autonomous driving control may be a control process in which the vehicle control ECU 20 controls at least one of the accelerator operation, the brake operation, and the steering wheel operation, which are the maneuvers related to the behavior of the vehicle out of the vehicle maneuvers. Manual driving using user's driving maneuvers is described as a control process in which the user performs all of the accelerator operation, the brake operation, and the steering wheel operation, which are the maneuvers related to the behavior of the vehicle out of the vehicle maneuvers.

In the first and second embodiments, the navigation system 1 executes the autonomous driving implementation section setting program (FIG. 2). However, the vehicle control ECU 20 may execute the autonomous driving implementation section setting program. In this case, the vehicle control ECU 20 obtains the current location of the vehicle, map information, traffic information, etc. from the navigation system 1.

The inventive principles are applicable to devices having a route search function, in addition to navigation systems. For example, exemplary embodiments contemplate a mobile phone, a smartphone, a tablet computer, a personal computer, etc. (hereinafter referred to as the “mobile terminal etc.”). exemplary embodiments contemplate systems formed by a server and the mobile terminal etc. In this case, each step of the above autonomous driving implementation section setting program (FIG. 2) may be executed by either the server or the mobile terminal etc. In the mobile terminal etc. embodiments, a vehicle capable of performing autonomous driving control and the mobile terminal etc. need be connected (either wired or wireless) such that they can communicate with each other.

Although the embodiments of the autonomous driving assist system are described above, the autonomous driving assist system may have the following configurations. In that case, the autonomous driving assist system has the following effects.

For example, a first configuration is as follows.

The autonomous driving assist system is characterized by including: route setting means for setting a planned route of a vehicle including an autonomous driving section where autonomous driving control of the vehicle is permitted; exclusion section setting means for setting, as a transition exclusion section, a section where a transition from autonomous driving control to manual driving using user's driving maneuvers is determined to be difficult to make in the planned route; transition section setting means for setting a transition section where the transition from autonomous driving control to manual driving is made in the planned route excluding the transition exclusion section; and autonomous driving section deciding means for deciding, according to the transition section set by the transition section setting means, a section where autonomous driving control is performed in the planned route.

According to the autonomous driving assist system having the above configuration, the transition section where a transition from autonomous driving control to manual driving using user's driving maneuvers is made is set in the planned route excluding the section where a transition from autonomous driving control to manual driving is determined to be difficult to make. This can reduce the burden that is imposed on the user when a transition from autonomous driving control to manual driving is made. For example, the user is not required to perform complicated maneuvers or advanced maneuvers immediately after the transition, namely when he/she has not gotten used to driving again. This allows a smooth transition from autonomous driving control to manual driving to be made, so that the vehicle can travel stably even after a transition to manual driving. The place that can be set as the transition section is not limited to a rest area or a parking area, and a mainline can also be set as the transition section. This can prevent the section where autonomous driving control is performed from becoming unnecessarily short.

A second configuration is as follows.

The autonomous driving assist system is characterized in that the exclusion section setting means sets, as the transition exclusion section, a section where a burden of a vehicle maneuver to be performed by the user after the transition to manual driving is greater than a certain amount.

According to the autonomous driving assist system having the above configuration, the transition section can be set such that the burden of the vehicle maneuver to be performed by the user immediately after a transition from autonomous driving control to manual driving is not large. Accordingly, the user can appropriately continue to drive the vehicle even immediately after such a transition, namely even when he/she has not gotten used to driving again.

A third configuration is as follows.

The autonomous driving assist system is characterized in that the exclusion section setting means sets, as the transition exclusion section, a low visibility section, a section with a bad road surface condition, or a section where a predetermined amount or more of break operation or steering operation need be performed within a predetermined time.

According to the autonomous driving assist system having the above configuration, the user is not required to perform complicated maneuvers or advanced maneuvers immediately after the transition, namely when he/she has not gotten used to driving again. This allows a smooth transition from autonomous driving control to manual driving to be made, so that the vehicle can travel stably even after the transition to manual driving.

A fourth configuration is as follows.

The autonomous driving assist system is characterized by further including: manual driving section obtaining means for obtaining a manual driving section where the vehicle needs to travel by manual driving in the planned route, wherein the transition section setting means sets, as the transition section, a section which is located before a start point of the manual driving section and closest to the start point of the manual driving section and for which a length equal to or greater than a predetermined distance can be secured, in the planned route excluding the transition exclusion section.

According to the autonomous driving assist system having the above configuration, even if the planned route includes the manual driving section where the vehicle needs to travel by manual driving, the transition section can be set so as to be located before the manual driving section and to make a section where the vehicle travels by autonomous driving control as long as possible.

A fifth configuration is as follows.

The autonomous driving assist system is characterized by further including: plan creating means for creating a lane travel plan, or a plan of how the vehicle travels in a lane when it travels along the planned route, wherein the transition section setting means sets the transition section in view of the lane travel plan.

According to the autonomous driving assist system having the above configuration, a section where a complicated maneuver or an advanced maneuver is required can be accurately specified in advance by using the lane travel plan. The transition section can therefore be set such that the user is not required to perform a complicated maneuver or an advanced maneuver immediately after a transition, namely when he/she has not gotten used to driving again.

A sixth configuration is as follows.

The autonomous driving assist system is characterized by further including: lane change section specifying means for specifying a lane change section, or a section where the vehicle makes a lane change in the lane travel plan, wherein the transition section setting means sets the transition section in the planned route excluding both the transition exclusion section and the lane change section.

According to the autonomous driving assist system having the above configuration, particularly a section where the vehicle is required to make a lane change can be accurately specified in advance by using the lane travel plan. The transition section can therefore be set such that the user is not required to perform a maneuver associated with a lane change immediately after a transition, namely when he/she has not gotten used to driving again.

A seventh configuration is as follows.

The autonomous driving assist system is characterized by further including: control content setting means for setting a content of autonomous driving control to be performed on the vehicle in the section where autonomous driving control is performed in the planned route.

According to the autonomous driving assist system having the above configuration, the content of autonomous driving control to be performed on the vehicle when it travels along the planned route can be set in view of the section where autonomous driving control is performed.

An eighth configuration is as follows.

The autonomous driving assist system is characterized by further including: autonomous driving section obtaining means for obtaining the autonomous driving section, wherein any manual driving section where the vehicle needs to travel by manual driving in the planned route of the vehicle is specified based on the autonomous driving section, and at least the manual driving section located ahead of, and closest to, a current location of the vehicle in a traveling direction is obtained, and the transition section setting means sets the transition section based on the obtained manual driving section and the transition exclusion section.

According to the autonomous driving assist system having the above configuration, the transition section can be set based on the manual driving section and the transition exclusion section.

A ninth configuration is as follows.

The autonomous driving assist system is characterized in that the exclusion section setting means sets a section where the vehicle merges into traffic as the transition exclusion section.

According to the autonomous driving assist system having the above configuration, the section where the vehicle merges into traffic can be set as the transition exclusion section.

1. An autonomous vehicle driving assist system, comprising:
a processor programmed to:
set a planned route of a vehicle, the planned route including an autonomous driving section where autonomous driving control of the vehicle is permitted;
set a transition exclusion section of the planned route where a transition from autonomous driving control to manual driving is determined to be difficult;
set a transition section of the planned route where the transition from autonomous driving control to manual driving is made and which excludes the transition exclusion section; and
based on the transition section, determine a section where autonomous driving control is performed in the planned route.

2. The autonomous vehicle driving assist system according to claim 1, wherein the processor is programmed to:
set, as the transition exclusion section, a section where a burden of a vehicle maneuver to be performed by the user after the transition to manual driving is greater than a predetermined amount.

3. The autonomous vehicle driving assist system according to claim 2, wherein the processor is programmed to:
set, as the transition exclusion section, a low visibility section, a section with a bad road surface condition, or a section where a predetermined amount or more of break operation or steering operation need to be performed within a predetermined time.

4. The autonomous vehicle driving assist system according to claim 1, wherein the processor is programmed to:
obtain a manual driving section where the vehicle needs to travel by manual driving in the planned route; and
set, as the transition section, a section which is located before a start point of the manual driving section and closest to the start point of the manual driving section and for which a length equal to or greater than a predetermined distance can be secured, in the planned route excluding the transition exclusion section.

5. The autonomous vehicle driving assist system according to claim 1, wherein the processor is programmed to:
create a lane travel plan, or a plan of how the vehicle travels in a lane when it travels along the planned route; and
set the transition section in view of the lane travel plan.

6. The autonomous vehicle driving assist system according to claim 5, wherein the processor is programmed to:
specify a lane change section, or a section where the vehicle makes a lane change in the lane travel plan; and
set the transition section in the planned route excluding both the transition exclusion section and the lane change section.

7. The autonomous vehicle driving assist system according to claim 1, wherein the processor is programmed to:
set a content of autonomous driving control to be performed on the vehicle in the section where autonomous driving control is performed in the planned route.

8. The autonomous vehicle driving assist system according to claim 7, wherein the processor is programmed to:
obtain the autonomous driving section;
specify any manual driving section where the vehicle needs to travel by manual driving in the planned route of the vehicle based on the obtained autonomous driving section;
obtain at least the manual driving section located ahead of, and closest to, a current location of the vehicle in a traveling direction; and
set the transition section based on the obtained manual driving section and the transition exclusion section.

9. The autonomous vehicle driving assist system according to claim 8, wherein the processor is programmed to:
set a section where the vehicle merges into traffic as the transition exclusion section.

10. An autonomous vehicle driving assist method, comprising:
setting a planned route of a vehicle, the planned route including an autonomous driving section where autonomous driving control of the vehicle is permitted;
setting a transition exclusion section of the planned route where a transition from autonomous driving control to manual driving is determined to be difficult;
setting a transition section of the planned route where the transition from autonomous driving control to manual driving is made, and which excludes the transition exclusion section; and
based on the transition section, determining, a section where autonomous driving control is performed in the planned route.

11. A computer-readable storage medium storing an autonomous vehicle driving assist program, as the program causing a computer to perform functions comprising:
setting a planned route of a vehicle, the planned route including an autonomous driving section where autonomous driving control of the vehicle is permitted;
setting a transition exclusion section of the planned route where a transition from autonomous driving control to manual driving is determined to be difficult;
setting a transition section of the planned route where the transition from autonomous driving control to manual driving is made, and which excludes the transition exclusion section; and
based on the transition section, determining a section where autonomous driving control is performed in the planned route.
